(19) United States
(12) Patent Application Publication
(10) Pub. No.: US 2002/0078322 A1
(43) Pub. Date: Jun. 20, 2002

(54) Method for rapid communication within a parallel computer system, and a parallel computer system operated by the method

(76) Inventor: Anton Gunzinger, Zuerich (CH)

Correspondence Address: OPPEDAHL AND LARSON LLP, P O BOX 5068, DILLON, CO, 80435-5068, US

(21) Appl. No.: 09/954,596

(22) Filed: Sep. 12, 2001

Related U.S. Application Data
(63) Continuation of application No. 09/121,493, filed on Jul. 23, 1998, now abandoned.
(60) Provisional application No. 60/053,207, filed on Jul. 21, 1997.

(51) Int. Cl. G06F 15/00

(52) U.S. Cl. 712/29; 712/30

(57) ABSTRACT

The method operates a parallel computer system with distributed memory. Each processor element has a local program memory, data memory and communications memory. Each processor element contains a communications manager unit with an address comparator and an address computation unit with entailed functionality. All processors globally write the global data and locally read the global data. A global address is adjoined to data written globally. For each processor element, an address comparator determines from the address whether the specific processor element is interested in these data. If yes, a local address computer determines the physical address in the processor memory. The parameters of the address comparator are agreed upon with the operating system before or during computation. The invention creates scalable multi-processor systems offering high communications performance using standard operating systems.

### FIELD OF THE INVENTION

The present invention relates to a method for operating a parallel computer system and to a parallel computer system operated by means of the method.

### BACKGROUND OF THE INVENTION

The demand for computing capacity has been rising and will also be rising in the coming years on account of new computer applications such as data banks, “video on demand”, audio and internet servers. Such computing capacity can be delivered economically only by using parallel computer systems.

Gorden Bell has divided parallel computer systems in four classes:

1. multiprocessors with message passing

2. multiprocessors with a shared memory

3. multicomputers with message passing

4. multicomputers with a shared memory.

In multiprocessors each individual processing element has its own arithmetic-logic unit (ALU), its own program control and its own memory. The individual processor is not operable at system boot-up; the program and the data first are downloaded from a central site.

Multicomputers are composed of complete computer systems with ALU, program control, their own memory and their own boot program. An appropriate communication control unit is present for communications.

Communications may be implemented either from a shared memory or by exchanging messages.

In systems comprising shared memories, access to memory may turn into a bottleneck; for that reason, such systems are not easily scalable. However, they are easy to program and most have low latency. Digital Equipment, Silicon Graphics and other manufacturers offer such systems commercially. The meaningful maximum size of such system is about 32 processors.

Message-passing systems are more scalable; systems having up to 10,000 processors have been built. However, as a rule they present difficulties when being programmed and low latencies can be achieved only by means of special operating systems. Herein the expression “latency” denotes the time elapsing from the call of the communication function on a transmitter processor to arrival of data at the receiver processor.

### SUMMARY OF THE INVENTION

An object of the present invention is to provide a scalable multiprocessor system having high communications performance (high bandwidth, low latency) using standard operating systems Windows NT, UNIX etc) and to provide a method for its operation.

The present invention is part of the group of multiprocessors. The programming model is similar to the shared memory. However, the data are communicated by message passing. In this manner the advantages of both procedures, namely simple programming (shared memory) and scalability (message passing) can be combined

For reasons of economy, PCs or workstations are appropriately used as single computing elements. Because of their large numbers, they are commercially offered at economical prices. The standard operating systems such as Windows NT or UNIX entail unacceptably high latencies that heretofore have precluded their use.

The present invention now makes it possible to achieve low latencies even when using standard operating systems. As a result, parallel high-performance computer systems may be built up hereafter using standard components (hardware and operating system). In addition, a programming model may be used which closely matches the programming model of the shared memory. Thereby it is possible to set up programs more rapidly. Finally this new design evinces a very fast synchronizing function, for instance barrier synchronization (all processors reaching one hit point), events (a single processor detecting an event) and key management for exclusive activities. Moreover, special functions on the communicated data such as computing sums, minima or maxima, are possible.

### BRIEF DESCRIPTION OF THE DRAWINGS

FIG. 1 is a schematic block diagram of a conventional multiprocessor system with distributed memory and the course of communication between two processors of the state of the art;

FIG. 2 is a schematic block diagram of a computer system in accordance with the invention;

FIG. 3 is a memory map diagram showing the relation between global address space and local address space; and

FIG. 4 is a block diagram of the communication management unit of the present invention.

### DESCRIPTION OF PREFERRED EMBODIMENTS

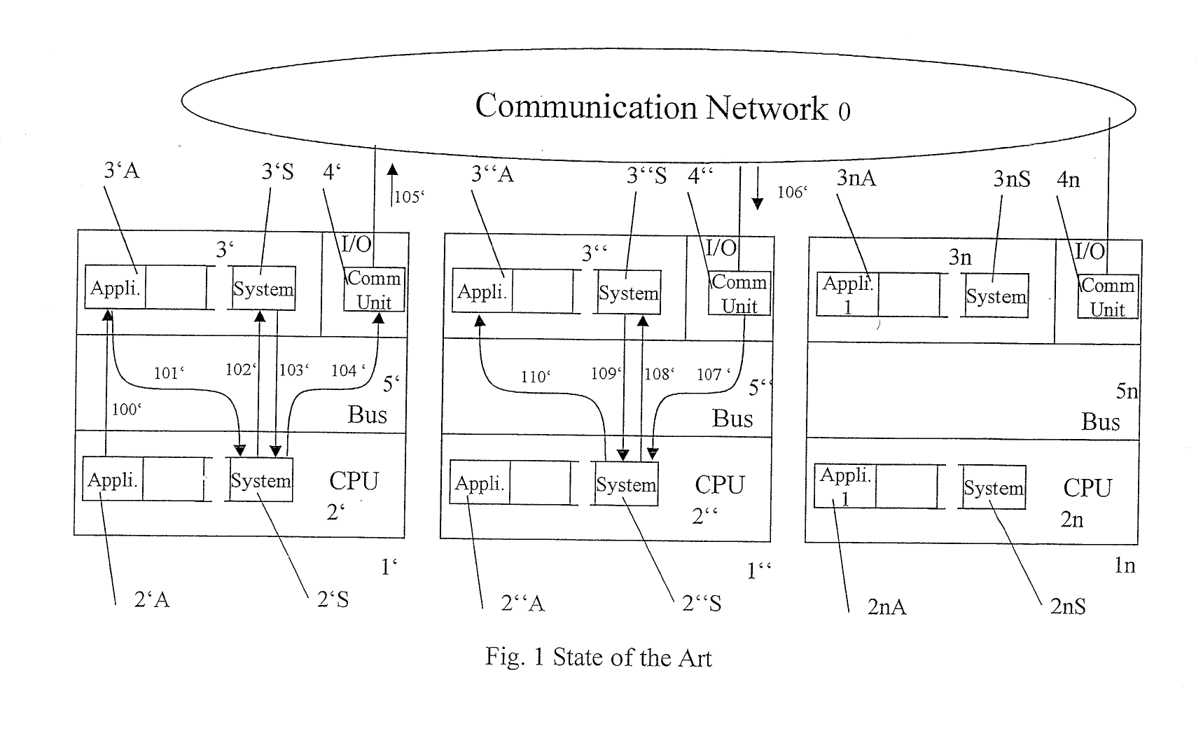

Familiarity with the operation of a present-day system is necessary for an understanding of the operation of the present invention. A multiprocessor system of the state of the art is shown in FIG. 1.

A parallel computer system contains n processing elements 1′, 1″ . . . 1ⁿ, where n=2, 3 . . . and is a natural number equal to or larger than 2. These at least two processor elements are connected to one another by a shared communications network 0 appropriately evincing wide bandwidth and low latency. No assumptions are made concerning the communications network. Illustratively “Fast Ethernet”, ATM, GigaBit Ethernet, Fiber Channel or any other fast network may be used. Again no assumptions are made concerning topology; buses, stars, rings, 2-D or 3-D networks (torus) may be used, or any other topology. The costs and performances of such networks differ and must be matched to needs. A single processor element 1′, 1″ . . . 1ⁿ in consists of a control and computation unit (CPU) 2′, 2″ . . . 2ⁿ, a memory 3′, 3″ . . . 3ⁿ and a communication unit 4′, 4″ . . . 4ⁿ.

Typically the memories 3′, 3″ . . . 3ⁿ are divided into an application area 3′A, 3″A . . . 3ⁿA and a system area 3′S, 3″S . . . 3ⁿS. Be it assumed that a first processor 1′ intends to transmit a message to a second processor 1″. A message exchange takes place as follows:

A first control and computing unit 2′ has generated data it wishes to communicate. For that purpose it stores the data into a first application memory 3′A denoted by an arrow 100′. Now the operating system must be notified that the data is to be communicated. To assure that the data remain unchanged during communication, the operating system copies the data denoted by an arrow 101′ and writes them into a first system memory 3′S (102′). Once a first communication unit 4′ has been readied, the data are again read out of the first control and computing unit 2′ (103′) and are transferred to the first communication unit 4′ (104′). When using a DMA (Direct Memory Access) controller, the last step can be simplified. The DMA autonomously retrieves the data from the system memory and writes them into the first communication unit 4′. At the receiving side the data first arrive in a second communication unit 4″ (106′). Therein they are fetched by a second control and computing unit 2″ (107′) and stored in a second system memory 3″S (108′). This interim storage is required because of the possibility of the application not being ready to receive the data. As soon as the application is able to receive the data, the operating system copies the data from the second system memory 3″S (109′) into a second application memory 3″A (110′). The data transmission system (bus) 5′ or 5″ is highly loaded by these many data transfers; the data are shifted up to 5 times per processor. When error detection during transfer entails additional check sums, the number of data shifts will be still higher. Moreover such systems evince high latencies that may amount to more than 1,000 μs.

The present invention drastically reduces the number of copies; as a result the communications bandwidth is widened by a factor more than 4. Moreover the latency may be reduced by 2 orders of magnitude to less than 10 μs.

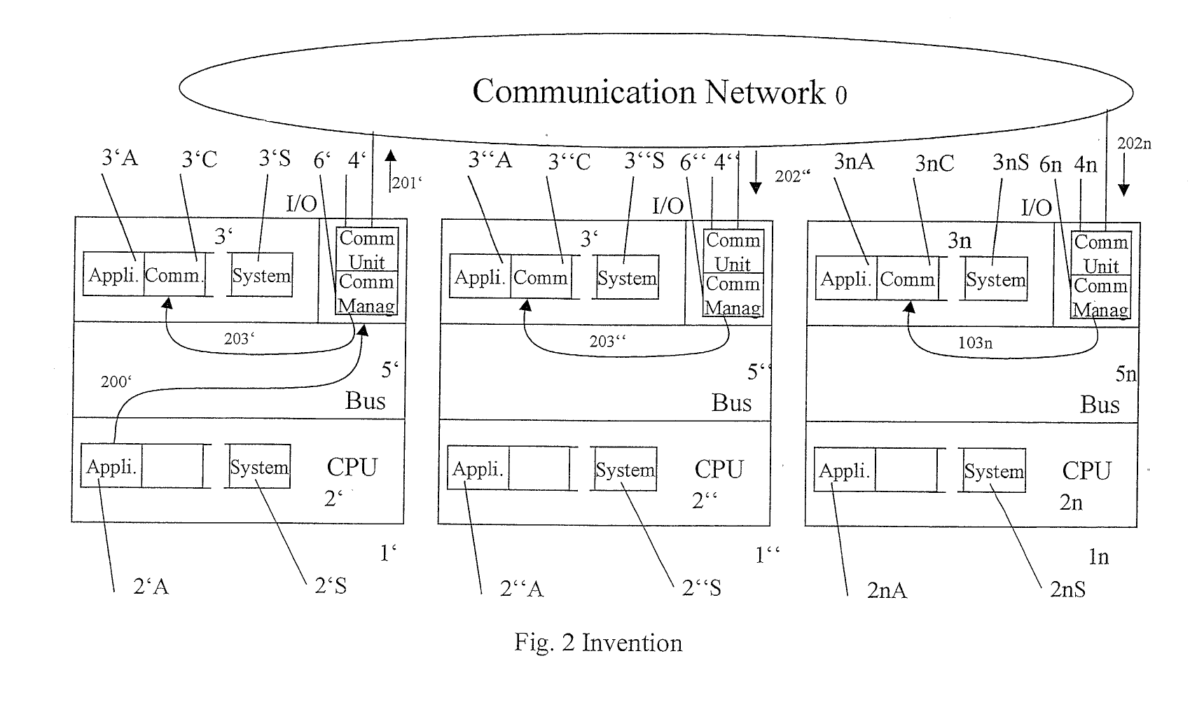

FIG. 2 shows the configuration of a computer system of the invention. In this instance too this is a parallel computer system comprising n processor elements 1′, 1″ . . . 1ⁿ, where n=1, 2 . . and is a natural number. These processor elements are connected to each other by a common communications network 0 appropriately evincing a large bandwidth and low latency. Additionally to a standard computer system, in the invention, a communication manager unit 6′, 6″ . . . 6ⁿ is inserted between the communications unit 4′, 4″ . . . . 4ⁿ and the local data transfer system 5′, 5″ . . . 5ⁿ. The local data memory 3′, 3′ . . . 3ⁿ is fitted with a new segment: a communications buffer memory 3′C is introduced in addition to the system memory 3′S and the application memory 3′A. Both the application and also the communications manager unit 6′. 6″ . . . 6ⁿ have access to said segment. Several application data memories 3′B and communications buffer memories 3′C may also be present in systems with several running applications. By using virtual memory address, application memory 3′A, communication memory 3′C and system memory 3′S may be virtually one block, but physically distributed among several pages as is usual with virtual addressing.

In the method of the invention, the processor writes the results of its computations into the communications manager unit 6′ or 6″ . . . 6ⁿ (200′). Said unit adds a global address. The data values and the address are transferred to the communications unit 4′ (201′) and, passing through the conventional communications network 0 (201′), arrive at the communications units 4′, 4″ . . . 4ⁿ (202″ . . . 202ⁿ) .The communications manager unit 6′, 6″ . . . 6ⁿ compares the global address of the incoming data with predefined values previously provided by the application. This comparison determines whether the processor is at all interested in these data. Irrelevant data are merely ignored by the communications manager 6′, 6″ . . . 6ⁿ. As regards relevant data, a local memory address in the communications memory 3′C, 3″C . . . 3ⁿC will be computed and they will be saved therein directly (203′, 203″ . . . 203ⁿ)

Reading always will be local and writing always will be global as regards common data in the method of the invention. In actual applications, reading is 10 to 10,000 times more extensive than writing; as a result a striking gain in speed can be achieved. The data are not additionally copied in the method of the invention; this feature also is called “zero copying”. Because only writing on a “remote” processor takes place for data exchange, the terminology “remote store” has been selected.

Each communications manager unit 6′ comprises an address comparator which determines whether the particular processor element is interested in the data, and an address computation unit using the global address to compute the local physical address in the communications memory 3′C, 3″C . . . 3ⁿC.

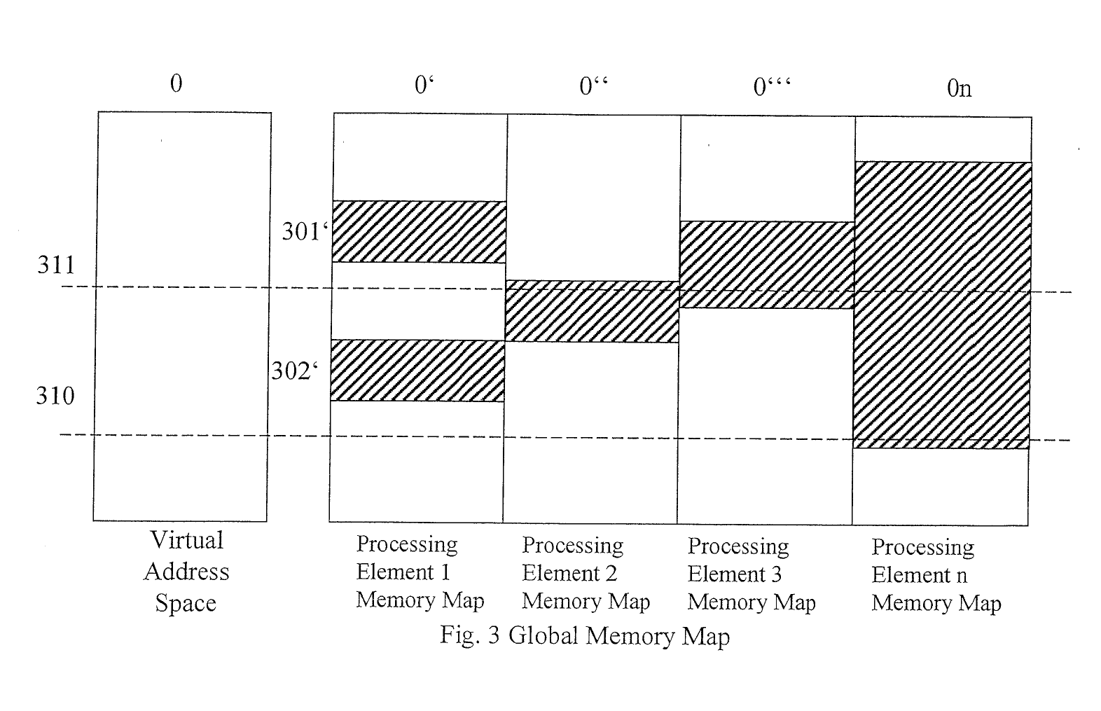

A detailed view of the remote-store concept is shown in FIG. 3. A globally virtual address space 0 is defined again for the entire parallel computer system. Each processor element can insert one or more windows into this address space; for instance in FIG. 3 the processor 1′ (see FIG. 2) determines the areas 301′ and 302″. If now writing in the address space to a global address takes place (for instance 310) that is located in a window, then the local communication manager units fetch the data, convert the global addresses into a local physical address and there store the data.

As shown by FIG. 3, not all processor elements may be interested in the data because their address windows have not been set at the specific addresses (311).

An address comparator may manage one or more windows each having a start address and an end address, and all data having addresses within the address window are locally processed (FIG. 3). Another possible solution is to divide the global address space into pages and use a table in the address comparator to specify which data is to be processed locally.

Address computation determines the local address in the communications memory 3′C, 3″C . . . 3ⁿC (FIG. 2) by counting an offset into the global address. In a simpler procedure, one or more bits (most of the time the leading ones) of the global address are replaced by a base value. However, a table can also be used to provide the physical addresses for the individual pages. This procedure offers foremost advantages in virtual addressing.

Aside from the main functions of address-comparison/address-computation of the unit 6′, 6″ . . . 6ⁿ (FIG. 2), the communications manager unit may be broadened by functions useful in parallel processing, for instance:

Synchronization barriers: One or more processors have reached a hit site. A signal is emitted (program interrupt) or a status register in the communications manager unit 6′. 6″ . . . 6ⁿ (FIG. 2) is set,

Event: A processor has reached an event (for instance found data in a data bank). A signal is emitted (program interrupt) or a status in the communications manager unit 6′, 6″ . . . 6ⁿ is set,

One or more keys are managed by the communications manager units 6′, 6″ . . . 6ⁿ. A single processor 1′, 1″ . . . 1ⁿ is able to demand the key from its communications manager unit 6′, 6″ . . . 6ⁿ. Discussion between the communications manager units 6′, 6″ . . . 6ⁿ assures that the key shall be made available exclusively to one processor 1′, 1″ . . . 1ⁿ. This functionality is required for instance for changes in data banks,

The communications manager units 6′, 6″ . . . 6ⁿ also may manage one or more message buffers. The computing/control units 2′, 2″ . . . 2ⁿ are informed only after the message has been saved in the memory 3′, 3″ . . . 3ⁿ,

The communications manager units 6′, 6″ . . . 6ⁿ compute higher functions on the communicated data, for instance maximum, minimum or sum. The computing/control unit is thereby relieved of this work and the reply time is shorter,

Complex data structures such as 2- or n-dimensional arrays composed of many single values are autonomously collected, combined by the communications manager unit and significant portions are copied into the local memory 3′, 3″ . . . 3ⁿ (FIG. 2),

Further functions defined by the user are conceivable that will be carried out by the communications manager unit 6′, 6″ . . . 6ⁿ (FIG. 2). The object of all these special functions is to offer relief to the processor (CPU), to simplify programming and to increase overall system performance.

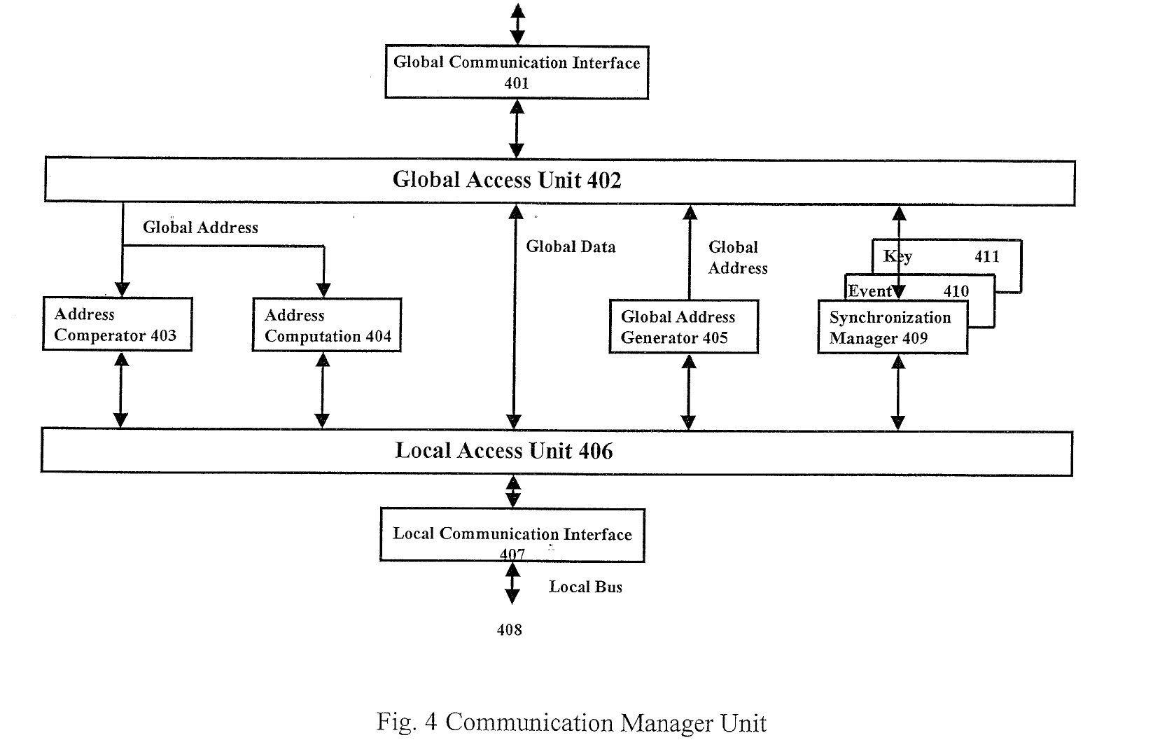

FIG. 4 shows a possible architecture of the communications manager unit, which is composed of the following:

global communication interface 401 (for instance ATM interface)

global access unit 402 (for example, an arbiter-fitted bus system)

address comparator 403 to compare the global address, the address significant for the local area,

address computation unit 404 converts the global address into the local address at the receiver

global address generator 405 converts the local address into the global address when writing (transmitting)

local access unit 406 (for example, a bus system with arbiter)

local communication interface 407, (for instance a PCI interface)

local bus 408

synchronization manager 409

event manager 410

key manager 411.

When writing (transmitting), a global address is computed from the local address using the global address generator 405 and is communicated through the global access unit 402 and the global communication interface 401 to the receivers. Upon being received, the messages pass through the global communication interface 401 and the global access unit 402 to the address comparator 403.

The address comparator 403 determines whether the processor element is interested in these data. If not, the data will be ignored; if yes, a local address is computed by the address computation unit 404 and the global data are entered directly through the local communication interface into the communication memory of the application.

Corresponding managers 409, 410 and 411 are provided for the barrier synchronization, “event” and “key” special functions. In the case of a board with several CPUs, part of the communication manager is multiplexed to support those CPUs.

In another implementing mode of the method of the invention, one or more processor elements 1′, 1″ . . . 1ⁿ (FIG. 2) act directly as input or output elements for instance for video cameras, video monitors, audio applications, radar systems etc.

In many cases the communications manager units 6′, 6″ . . . 6ⁿ (FIG. 2) can be integrated directly into the communications unit 4′, 4″ . . . 4ⁿ. In other cases a (programmable) gate array, a customer-specific circuit or a (fast) signal processor may be appropriately employed. If the network supports point-point, multicast and broadcast, the whole concept can make use of this functionality to reduce communication.

What is claimed is:

1. A method of operating a parallel computer system having at least two processor elements and having a distributed memory, each processor element comprising a local program memory, data memory, communications memory and an operating system, the method comprising the steps of
(a) in each processor element, globally writing global data and locally reading global data,
(b) adjoining a global address and/or a number to data written globally,
(c) for each processor element, determining with an address and/or a number comparator in each processor element on the basis of the address whether the particular processor element is interested in data written globally,
(d) determining with a local address computation unit a physical address in processor memory when the processor element is interested in the data, and
(e) establishing parameters of the address and/or number comparator and of the address computation unit in each processor element before or during processing with the operating system.

2. A method according to claim 1 including controlling the exchange of messages with a communications manager unit to make possible “zero copying”.

3. A method according to claim 1 wherein the address comparator comprises one or more address windows, each window comprising an initial address (base) and an end address (top) and that all data within one of these windows are processed further locally.

4. A method according to claim 1 including dividing global address space into pages and defining with a table in the address comparator which data are to be processed further locally.

5. A method according to claim 4 including adding an offset of one or more bits to a global address to determine a local address.

6. A method according to claim 4 including replacing one or more bits of the global address by a base value to determine a local address.

7. A method according to claim 4 including forming the table from one or more bits of the global address and/or number and entering a local address value co-determining the address for each table entry.

8. A method according to claim 1 including s electively transmitting global writing to selected groups of less than all processors in the system, thereby substantially reducing load on the network.

9. A method according to claim 1 wherein barrier synchronization, wherein all processor elements have reached a hit point, is supported by a communications manager unit.

10. A method according to claim 1 including transferring event recognition by a single processor through a communications manager unit to the entire system.

11. A method according to claim 1 including supporting one or more exclusive keys with a communications manager unit.

12. A method according to claim 1 wherein one or more processor elements act directly as input and/or output elements.

13. A parallel computer system comprising
at least two processor elements with distributed memory, each processor element comprising a local program memory, a data memory, a communications unit for writing data globally and reading data locally, a communications memory and an operating system, each processor element including a communications manager unit to control the communications unit.

14. A parallel computer system according to claim 13 wherein each communications manager unit is inserted between each communications unit and a local data transport system of each processor element.

15. A parallel computer system according to claim 13 wherein each communications manager unit comprises an address comparator and an address computation unit.
